(19) United States
(12) Patent Application Publication
(10) Pub. No.: US 2026/0311663 A1
(43) Pub. Date: Oct. 8, 2026

(54) MUSICAL DRUM ATTENUATOR

(71) Applicant: Musical Accessories Unlimited LLC, Crown Point, IN (US)

(72) Inventor: John T. Mick, Crown Point, IN (US)

(73) Assignee: Musical Accessories Unlimited LLC, Crown Point, IN (US)

(21) Appl. No.: 19/173,303

(22) Filed: Apr. 8, 2025

(51) Int. Cl. G10D 13/14; G10D 13/02

(52) U.S. Cl. CPC G10D 13/14; G10D 13/02

(57) ABSTRACT

The present invention relates to a device, system, and method for dampening and/or altering the sound produced by a musical drum. The device is a homogenous elastomeric sheet which dampens and/or alters the sound produced by a musical drum when placed on the playing surface thereof. The system and method include securing the homogenous elastomeric sheet to the playing surface between two magnets. The first magnet rests on a mounting surface affixed to the inner wall of the musical drum beneath the playing surface, the homogenous elastomeric sheet rests on the playing surface over the first magnet, and the second magnet rests on top of the homogenous elastomeric sheet. The attractive force between the two magnets secures the homogenous elastomeric sheet to the playing surface of the musical drum.

### FIELD OF INVENTION

The present invention relates to a device, system, and method for dampening and/or altering the sound produced by a musical drum.

### BACKGROUND

Drums play a critical role in many forms of music by providing songs with a rhythmic foundation. However, the sound produced by a drum can be loud and overpowering. As a result, a drum may drown out the sound of accompanying musical instruments or pose a nuisance to those close by. To overcome these noise concerns, several devices, systems, and methods have been developed to dampen and/or alter the sound produced by a drum.

Some drummers dampen and/or alter the sound of their drums by placing a pillow or other sound-absorbing material in the interior of their drum. However, this method requires removing and reattaching the drumhead whenever transitioning between a dampened/altered and unaltered drum sound.

As an alternative, some drummers place a sheet of material over the entirety of the playing surface of a drumhead to achieve a sound-altering effect. Such devices either rest on the playing surface or are held in place by an adhesive material. If resting freely on the playing surface, the sheet of material may be displaced from the vibrations created by the drummer striking the playing surface of the drumhead and, consequently, the desired dampening and/or sound-altering effect may be diminished. If secured to the playing surface with adhesive material, the sheet may be difficult to remove, leave behind residue, or lose its adhesive character over time.

Accordingly, a need exists for improved devices, systems, and methods for easily and effectively dampening and/or altering the sound produced by a musical drum.

### SUMMARY

To address the above and other deficiencies, the present invention contemplates an improved device, system, and method for dampening and/or altering the sound produced by a musical drum.

The device comprises a homogenous elastomeric sheet or “damper pad” which reduces the sound produced by a musical drum when placed on the playing surface thereof. In embodiments of the device, the damper pad may be formed of a material selected from the group consisting of polyurethane, leather, rubber, felt, fabric, or cork. By varying the dimensions of or the material comprising the damper pad, a drummer may change the timber, tone, sound duration, and volume of a musical drum. Further, in some embodiments, the damper pad may be elongated along a longitudinal axis.

Accordingly, it is one object of the present invention to provide a means for effectively dampening and/or altering the sound produced by a musical drum.

The system and method comprise securing the damper pad to the playing surface of a drumhead utilizing two magnets. Specifically, the system and method comprise a first magnet which rests on an L bracket affixed to the inner wall of a musical drum beneath the drumhead. The system and method further comprise a damper pad which rests on the playing surface over the first magnet. A second magnet is placed on the top surface of the damper pad. As a result of the attractive force between the magnets, the damper pad is secured to the playing surface of the drumhead. A drummer may easily remove the damper pad from the playing surface by removing the second magnet from on top of the damper pad. By removing the second magnet without also removing the damper pad from the playing surface, the drummer may achieve different sound effects as the damper pad is allowed to flap up and down as the playing surface is struck by the drummer. In some embodiments of the system and method, the L bracket may contain a plurality of screw holes such that it may be affixed to the inner wall of a musical drum using at least one of a plurality of existing mounting screws for drum lugs. In some embodiments, the first magnet may have an adhesive strip for securing it to the L bracket beneath the drumhead. Further, in some embodiments, the magnets may each comprise an alnico magnet.

Thus, it is another object of the present invention to provide a drummer with an easy and efficient means for transitioning between a dampened/altered and unaltered drum sound.

It is noted that in the present disclosure and particularly in the claims and/or paragraphs, terms such as “comprises,” “comprised,” “comprising” and the like can have the meaning attributed to them in U.S. patent law; e.g., they can mean “includes”, “included”, “including”, and the like.

These and other embodiments are disclosed or are obvious from and encompassed by the following Brief Description of the Drawings and Detailed Description.

### BRIEF DESCRIPTION OF THE DRAWINGS

Certain embodiments are shown in the drawings. However, it is understood that the present disclosure is not limited to the arrangements and instrumentality showing in the attached drawings.

FIG. 1A is a side view of a damper pad.

FIG. 1B is an overhead view of a damper pad.

FIGS. 2A and 2B are alternative perspective views of an L bracket suitable for use in accordance with the present invention.

FIG. 3 is a cross-sectional view of a musical drum including a damper pad, an L bracket, and two magnets configured in accordance with the present invention.

FIG. 4 is an overhead view of a drumhead with a damper pad magnetically secured to the playing surface thereof.

FIG. 5 is a perspective view of the interior of a musical drum, wherein an L bracket is affixed thereto using existing mounting screws for drum lugs.

FIG. 6 is a block diagram illustrating a method to dampen and/or alter the sound produced by a musical drum.

### DETAILED DESCRIPTION

For the purposes of promoting and understanding the principles disclosed herein, reference is now made to the preferred embodiments illustrated in the drawings, and specific language is used to describe the same. It is nevertheless understood that no limitation of the scope of the invention is hereby intended. Such alterations and further modifications in the illustrated devices and such further applications of the principles disclosed and illustrated herein are contemplated as would normally occur to one of skill in the art to which this disclosure relates.

### Damper Pad Device

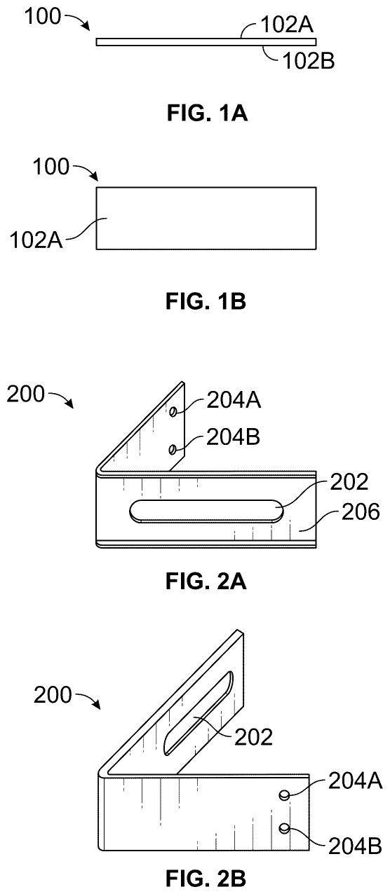

FIGS. 1A and 1B depict a device to dampen and/or alter the sound produced by a musical drum. The device comprises a homogenous elastomeric sheet 100 having a top surface 102A and a bottom surface 102B. When placed on a playing surface 402 of a drumhead 312, the homogenous elastomeric sheet 100 or “damper pad” dampens and/or alters the sound produced by a musical drum 300 by changing the vibrational frequency of the playing surface 402 as it is struck by a drummer. The damper pad can be sized to cover the entire playing surface or only a portion thereof. Preferably, the damper pad is elongated along a longitudinal axis, having a length of about 5 inches to about 7 inches and a width of about 1 inch to about 2 inches.

In embodiments of the device, the damper pad 100 may be formed of a material selected from the group consisting of polyurethane, leather, rubber, felt, fabric, or cork. By varying the dimensions of or the material comprising the damper pad 100, a drummer may change the timber, tone, sound duration, and volume of a musical drum.

### Application System

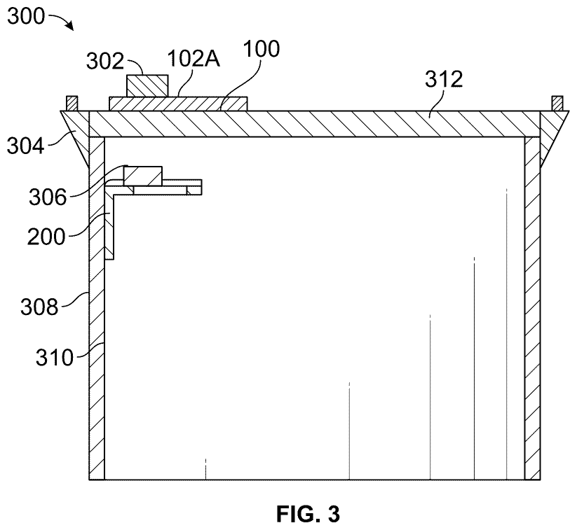

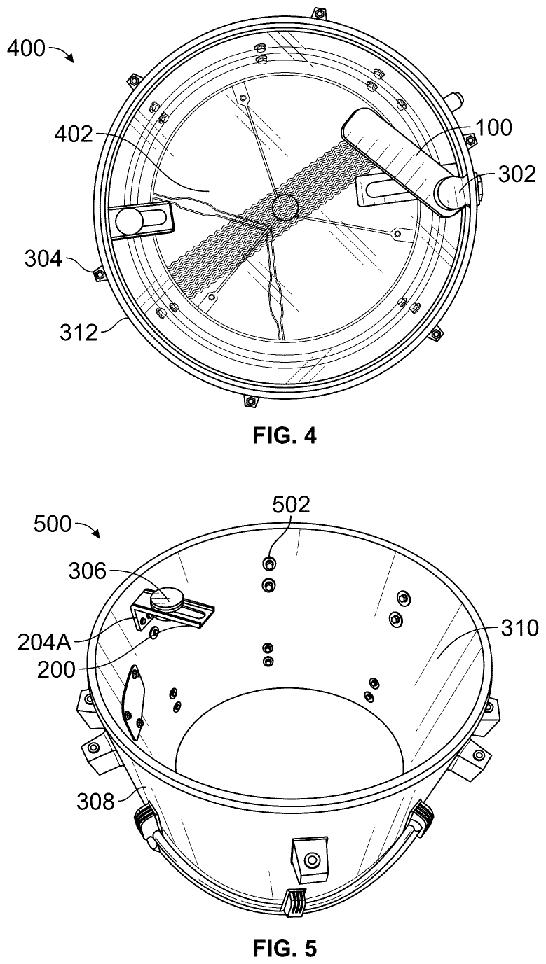

FIGS. 3 and 4 depict a system to dampen and/or alter the sound produced by a musical drum 300. The system comprises an L bracket 200 affixed to an inner wall 310 of a musical drum 300 beneath the drumhead 312, wherein a surface 206 of the L bracket 200 extends radially inward and parallel to the playing surface 402. A first magnet 306 rests on the surface 206 of the L bracket 200 beneath the drumhead 312. The system further comprises a damper pad 100 which rests on top of the playing surface 402 over the first magnet 306, and a second magnet 302 which rests on the top surface 102A of the damper pad 100. The attractive force between the first magnet 306 and the second magnet 302 secures the damper pad 100 to the playing surface 402 of the drumhead 312. A drummer may easily remove the damper pad 100 from the playing surface 402 of the drumhead 312 by first removing the second magnet 302 from the top surface 102A of the damper pad 100, thereby allowing the drummer to easily transition between a dampened/altered and unaltered drum sound. By removing the second magnet 302 without also removing the damper pad 100 from the playing surface 402, the drummer may achieve different sound effects as the damper pad 100 is allowed to flap up and down on the playing surface 402 as it is struck by the drummer.

In an embodiment of the system, the L bracket 200 may contain a plurality of screw holes 204A, 204B such that it may be affixed to the inner wall 310 of a musical drum 300 using existing mounting screws for drum lugs 502 as shown in FIG. 5. In some embodiments, the first magnet 306 may have an adhesive strip for securing it to the surface 206 of the L bracket 200. Further, in some embodiments, the magnets 302, 306 may each comprise an alnico magnet.

### Method of Use

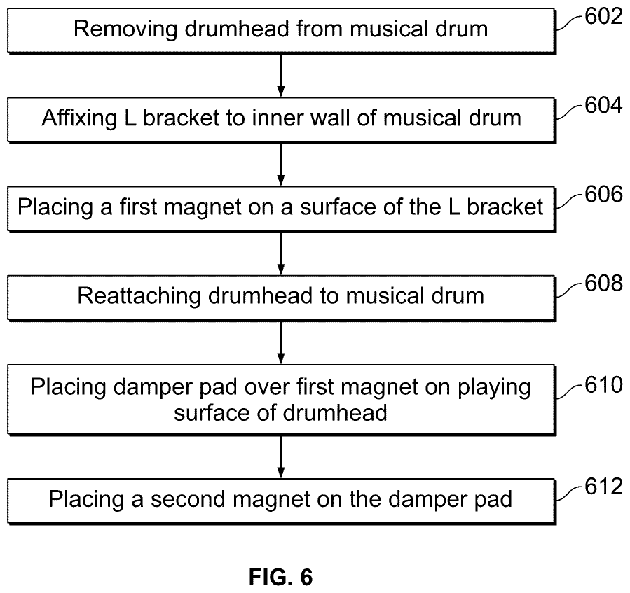

FIG. 6 is a block diagram illustrating a method to dampen and/or alter the sound produced by a musical drum 300 of the present disclosure 600. In a first step 602, the drumhead 312 is removed from a musical drum 300. In a second step 604, an L bracket 200 is affixed to the inner wall 310 of the musical drum 300, wherein a surface 206 of the L bracket 200 extends radially inward and parallel to the playing surface 402. In a third step 606, a first magnet 306 is placed on the surface 206 of the L bracket 200. In a fourth step 608, the drumhead 312 is reattached to the musical drum 300. In a fifth step 610, a damper pad 100 is placed on the playing surface 402 over the first magnet 306. In a sixth step 612, a second magnet 302 is placed on the top surface 102A of the damper pad 100 as shown in FIG. 3.

In an embodiment of the method 600, the L bracket 200 may contain a plurality of screw holes 204A, 204B and may be affixed to the inner wall 310 of a musical drum 300 using existing mounting screws for drum lugs 502 as shown in FIG. 5. In some embodiments, the first magnet 306 may have an adhesive strip for securing it to the surface 206 of the L bracket 200. Further, in some embodiments, the magnets 302, 306 may each comprise an alnico magnet.

What is claimed:

1. A sound dampening and/or altering device for a musical drum comprising a drumhead and a
playing surface, the device comprising:
a homogenous elastomeric sheet, whereby the homogenous elastomeric sheet, when placed on the playing surface of the drumhead, dampens and/or alters the sound produced by the musical drum being struck.

2. The device of claim 1, wherein the homogenous elastomeric sheet is formed of a material selected from the group consisting of polyurethane, leather, rubber, felt, fabric, or cork.

3. The device of claim 1, wherein the homogenous elastomeric sheet is elongated along a longitudinal axis.

4. The device of claim 3, wherein the homogenous elastomeric sheet has a length of about 5 inches to about 7 inches and a width of about 1 inch to about 2 inches.

5. A system for dampening and/or altering the sound of a musical drum comprising an inner wall, a drumhead, and a playing surface, the system comprising:
a mounting surface affixed to the inner wall of the musical drum beneath the drumhead, wherein the mounting surface extends radially inward and parallel to the playing surface;
a first magnet resting on the mounting surface beneath the drumhead;
a homogenous elastomeric sheet resting on the playing surface of the drumhead over the first magnet; and
a second magnet resting on the homogenous elastomeric sheet, whereby the attractive force between the first magnet and the second magnet secures the homogenous elastomeric sheet to the playing surface of the drumhead.

6. The system of claim 5, wherein the homogenous elastomeric sheet is formed of a material selected from the group consisting of polyurethane, leather, rubber, felt, fabric, or cork.

7. The system of claim 5, wherein the homogenous elastomeric sheet is elongated along a longitudinal axis.

8. The system of claim 7, wherein the homogenous elastomeric sheet has a length of about 5 inches to about 7 inches and a width of about 1 inch to about 2 inches.

9. The system of claim 5, wherein the mounting surface is a surface of an L bracket.

10. The system of claim 9, wherein the L bracket contains a plurality of screw holes and is affixed to the inner wall of the musical drum using at least one of a plurality of existing mounting screws for drum lugs.

11. The system of claim 5, wherein the first magnet comprises an adhesive strip for securing it to the mounting surface.

12. The system of claim 5, wherein the first and second magnet each comprise an alnico magnet.

13. A method for dampening and/or altering the sound of a musical drum comprising an inner wall, a drumhead, and a playing surface, the method comprising:
removing the drumhead from the musical drum;
affixing a mounting surface to the inner wall of the musical drum, wherein the mounting surface extends radially inward and parallel to the playing surface of the drumhead;
placing a first magnet on the mounting surface;
reattaching the drumhead to the musical drum;
placing a homogenous elastomeric sheet on the playing surface of the drumhead over the first magnet; and
placing a second magnet on the homogenous elastomeric sheet, whereby the attractive force between the first magnet and the second magnet secures the homogenous elastomeric sheet to the playing surface of the drumhead.

14. The method of claim 13, wherein the homogenous elastomeric sheet is formed of a material selected from the group consisting of polyurethane, leather, rubber, felt, fabric, or cork.

15. The method of claim 13, wherein the homogenous elastomeric sheet is elongated along a longitudinal axis.

16. The method of claim 15, wherein the homogenous elastomeric sheet has a length of about 5 inches to about 7 inches and a width of about 1 inch to about 2 inches.

17. The method of claim 13, wherein the mounting surface is a surface of an L bracket.

18. The method of claim 17, wherein the L bracket contains a plurality of screw holes and is affixed to the inner wall of the musical drum using at least one of a plurality of existing mounting screws for drum lugs.

19. The method of claim 13, wherein the first magnet comprises an adhesive strip for securing it to the mounting surface.

20. The method of claim 13, wherein the first and second magnet each comprise an alnico magnet.
